(19) United States
(12) Patent Application Publication
(10) Pub. No.: US 2022/0165475 A1
(43) Pub. Date: May 26, 2022

(54) INDUCTOR MODULE

(71) Applicant: Delta Electronics, Inc., Taoyuan City (TW)

(72) Inventors: Hsin-Wei Tsai, Taoyuan City (TW); Te-Chih Peng, Taoyuan City (TW); Min-Cheng Chiang, Taoyuan City (TW)

(21) Appl. No.: 17/394,165

(22) Filed: Aug. 4, 2021

(30) Foreign Application Priority Data
Nov. 20, 2020 (CN) 202011314766.9

(51) Int. Cl. H01F 27/26; H01F 27/28

(52) U.S. Cl. CPC H01F 27/263; H01F 27/28

(57) ABSTRACT

An inductor module includes at least one first magnetic core, a second magnetic core and at least one winding assembly. Each first magnetic core includes a connection part, a first post and a second post. The first post and the second post are disposed on a top surface of the connection part. A winding groove is formed between the first post and the second post. The second magnetic core is disposed adjacent to the first magnetic core. Each winding assembly is formed by wrapping a single metal sheet for at least one turn. Each winding assembly is disposed around the first post. A portion of each winding assembly is accommodated within the winding groove of the corresponding first magnetic core. An overall thickness of the winding assembly within the winding groove is smaller than or equal to a width W of the winding groove and greater than 0.9×W.

### CROSS-REFERENCE TO RELATED APPLICATION

This application claims priority to China Patent Application No. 202011314766.9, filed on Nov. 20, 2020, the entire content of which is incorporated herein by reference for all purposes.

### TECHNICAL FIELD

The present disclosure relates to an inductor module, and more particularly to a small-sized inductor module with increased efficiency and enhanced heat-dissipating efficacy.

### BACKGROUND OF THE INVENTION

Generally, many electronic devices are equipped with various magnetic elements such as transformers or inductors. The magnetic elements are operated according to the principle of electromagnetic induction and applicable to various circuit topologies. Conventionally, the winding assembly of the inductor is a combination of a plurality of coil pancakes, which are arranged side by side. Each coil pancake is formed by wrapping a coil. The coil is usually equipped with a coating layer on the outer surface. In case that the coil is wrapped for one turn, the thickness of the coil itself and two times the thickness of the coating layer contribute to the size of the coil pancake. As the coil is wrapped for more turns, the size of the coil pancake is largely increased. Due to the coating layer, the size of the coil pancake and the volume of the winding assembly are very large. Moreover, since a larger winding space is required, the volume of the conventional inductor is larger and detrimental to miniaturization. Moreover, since the coating layer on the outer surface of each coil of the winding assembly increases the copper loss, the efficiency of the conventional inductor is unsatisfied.

Therefore, there is a need of providing an inductor module to overcome the drawbacks of the conventional technology.

### SUMMARY OF THE INVENTION

An object of the present disclosure provides a small-sized inductor module with increased efficiency.

Another object of the present disclosure provides a small-sized inductor module with enhanced heat-dissipating efficacy.

In accordance with an aspect of the present disclosure, an inductor module is provided. The inductor module includes at least one first magnetic core, a second magnetic core and at least one winding assembly. Each first magnetic core includes a connection part, a first post and a second post. The first post and the second post are disposed on a top surface of the connection part. A winding groove is formed between the first post and the second post. The second magnetic core is disposed adjacent to the first magnetic core. Each winding assembly is formed by wrapping a single metal sheet for at least one turn. Each winding assembly is disposed around the first post of the corresponding first magnetic core. A portion of each winding assembly is accommodated within the winding groove of the corresponding first magnetic core. An overall thickness of the winding assembly within the winding groove is smaller than or equal to a width of the winding groove and greater than 0.9 times the width of the winding groove.

In accordance with another aspect of the present disclosure, an inductor module is provided. The inductor module includes three first magnetic cores and at least one winding assembly. A first one of the three first magnetic cores is arranged between a second one of the three first magnetic cores and a third one of the three first magnetic cores. Each of the three first magnetic cores includes a connection part, a first post and a second post. The first post and the second post are disposed on a top surface of the connection part, and a winding groove is formed between the first post and the second post. Each winding assembly is formed by wrapping a single metal sheet for at least one turn, and each winding assembly is disposed around the first post of the corresponding one of the three first magnetic cores, wherein a portion of each winding assembly is accommodated within the winding groove of the corresponding one of the three first magnetic cores, and an overall thickness of the winding assembly within the winding groove is smaller than or equal to a width of the winding groove and greater than 0.9 times the width of the winding groove. The first post of the first one of the three first magnetic cores is disposed adjacent to the first post of the second one of the three first magnetic cores, and the connection part of the first one of the three first magnetic cores is disposed adjacent to the first post of the third one of the three first magnetic cores.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the assembled structure of an inductor module according to a first embodiment of the present disclosure;

FIG. 2 is a schematic exploded view illustrating the inductor module as shown in FIG. 1;

FIG. 3 is a schematic perspective view illustrating the winding assembly for the inductor module as shown in FIG. 1, in which the winding assembly has not been wound on the magnetic core;

FIG. 4 is a schematic exploded view illustrating an inductor module according to a second embodiment of the present disclosure;

FIG. 5 is a schematic exploded view illustrating an inductor module according to a third embodiment of the present disclosure;

FIG. 6 is a schematic exploded view illustrating an inductor module according to a fourth embodiment of the present disclosure; and

FIG. 7 is a schematic exploded view illustrating an inductor module according to a fifth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. While the numerical ranges and parameters set forth for the broad scope of the present disclosure are approximations, the numerical value reported in the specific examples set forth as accurately as possible. However, any numerical values inherently contain certain errors necessarily the standard deviation found in the respective testing measurements caused. Also, as used herein, the term “about” or “substantially” means away from a given value or a range of 10%, 5%, 1% or 0.5%. Alternatively, the word “about” or “substantially” means within an acceptable standard error of ordinary skill in the art-recognized average.

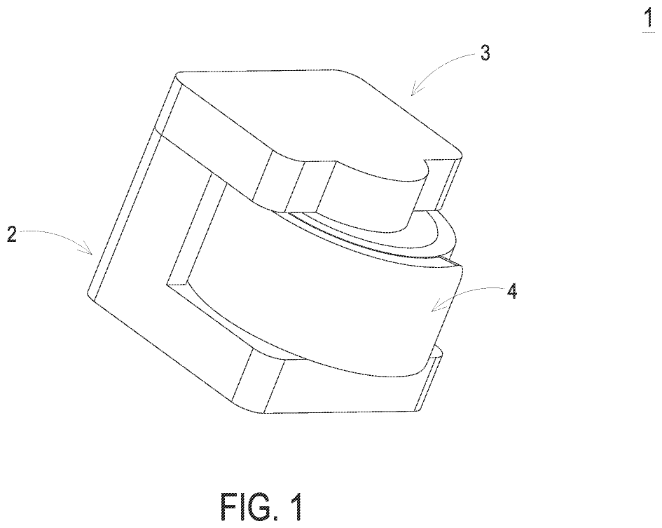

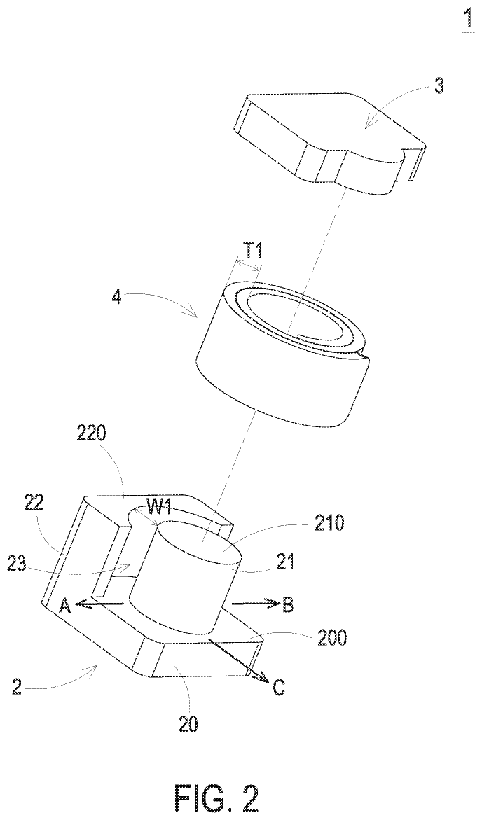

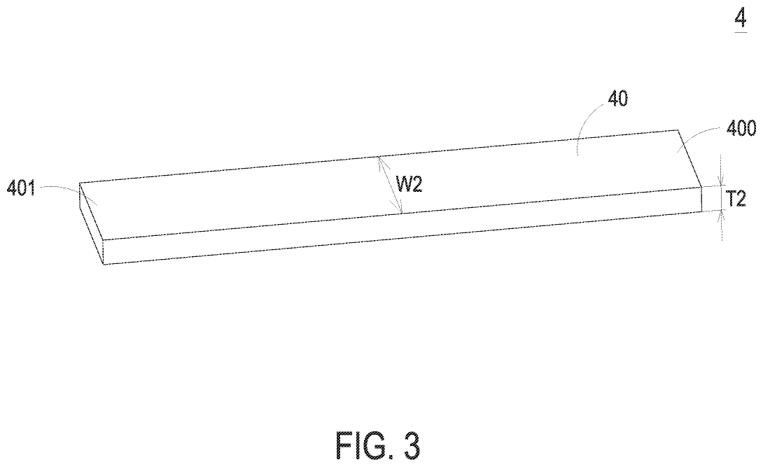

FIG. 1 is a schematic perspective view illustrating the assembled structure of an inductor module according to a first embodiment of the present disclosure. FIG. 2 is a schematic exploded view illustrating the inductor module as shown in FIG. 1. FIG. 3 is a schematic perspective view illustrating the winding assembly for the inductor module as shown in FIG. 1, in which the winding assembly has not been wound on the magnetic core. As shown in FIGS. 1, 2 and 3, the inductor module 1 is a single-inductor structure comprising a first magnetic core 2, a second magnetic core 3 and a winding assembly 4.

The first magnetic core 2 includes a connection part 20, a first post 21 and a second post 22. The first post 21 and the second post 22 are disposed on a top surface 200 of the connection part 20. The first post 21 and the second post 22 are disposed adjacent to two opposed sides of the top surface 200 of the connection part 20, respectively. Preferably but not exclusively, the first post 21 and the second post 22 are integrally formed with the connection part 20. Moreover, a winding groove 23 is formed between the first post 21 and the second post 22. It is noted that the position of the first post 21 is not restricted. For example, in another embodiment, the first post 21 is disposed at a middle region of the top surface 200 of the connection part 20. The second post 22 is disposed at an edge of the top surface 200 of the connection part 20.

The second magnetic core 3 is disposed adjacent to the first magnetic core 2 and covers a portion of the first magnetic core 2. For example, a top surface 210 of the first post 21 and a top surface 220 of the second post 22 are covered by the second magnetic core 3. Preferably but not exclusively, the second magnetic core 3 is an I-shaped core.

The winding assembly 4 is formed by wrapping a single metal sheet 40 (e.g., a copper sheet) for at least one turn. The winding assembly 4 is directly disposed around the first post 21 without the need of using a bobbin. Moreover, a portion of the winding assembly 4 is accommodated within the winding groove 23, and another portion of the winding assembly 4 is exposed outside the first magnetic core 2 and the second magnetic core 3. The overall thickness T1 of the winding assembly 4 within the winding groove 23 is substantially smaller than or equal to the width of the winding groove 23 and greater than 0.9 times the width of the winding groove 23.

Moreover, the winding assembly 4 further includes a first end part 400 and a second end part 401. The first end part 400 and the second end part 401 are disposed at two opposed ends of the winding assembly 4. Particularly, the first end part 400 is disposed at the outer side of the winding assembly 4, and the second end part 401 is disposed at the inner side of the winding assembly 4.

As mentioned above, the winding assembly of the conventional inductor is a combination of a plurality of coil pancakes, which are arranged side by side. Due to the coating layer, the size of the coil pancake and the volume of the winding assembly are very large. In accordance with the present disclosure, the winding assembly 4 is formed by wrapping the single metal sheet 40. Since the single metal sheet 40 has a flat sheet structure, a coating layer on a single surface of the single metal sheet 40 is feasible. In case that the single metal sheet 40 is wrapped for one turn, the thickness of the single metal sheet 40 and the thickness of the single coating layer contribute to the size of the winding assembly 4. When compares with the conventional inductor, the volume of the winding assembly 4 is reduced, and a smaller winding space is required. The volume reduction is helpful for the miniaturization of the inductor module 1. Moreover, since the copper loss of the winding assembly 4 is reduced, the efficiency of the inductor module 1 is increased.

Please refer to FIG. 2 again. As known, the conventional E-shaped magnetic core includes a middle post and two lateral posts. Consequently, as shown in FIG. 2, the heat generated by the E-shaped magnetic core can be dissipated along two lateral directions A and B only. In comparison with the E-shaped magnetic core, the structure of the first magnetic core 2 includes one middle post and a single lateral post. As shown in FIG. 2, the heat generated by the first magnetic core 2 can be dissipated along three lateral directions A, B and C. Consequently, the heat dissipating efficiency of the inductor module 1 is enhanced.

In an embodiment, the first post 21 has a cylinder-shaped structure. The second post 22 has a three-dimensional structure with a first surface and a second surface. The first surface faces the first post 21. The second surface is opposed to the first surface. It is preferred that the first surface of the second post 22 is a concave curved surface. Consequently, the winding groove 23 is suitably formed between the first post 21 and the first surface of the second post 22. It is noted that the shape of the second surface of the second post 22 is not restricted. In an embodiment, the second post 22 has a structure selected from a group consisting of an arch-shaped structure, a cylinder-shaped structure, a cube structure, a cuboid structure, a trapezoid structure, an ellipsoid structure, an irregular geometry-shaped structure and the combination thereof. In an embodiment, the area of a top surface 210 of the first post 21 is equal to the area of a top surface 220 of the second post 22. Moreover, the area of the top surface 200 of the connection part 20 is greater than the area of the bottom surface (nor shown) of the first post 21, which is connected to the top surface 200 of the connection part 20.

In another embodiment, the winding assembly 4 is formed by wrapping the single metal sheet 40 for two turns or three turns. It is noted that the turn number of the winding assembly 4 is not limited to the above embodiments and can be varied according to the practical requirements.

The ratio of the width of the single metal sheet 40 to the thickness T2 of the single metal sheet 40 is substantially greater than or equal to 0.5 and smaller than or equal to 20. For example, the thickness T2 of the single metal sheet 40 is substantially greater than or equal to 1 mm and smaller than or equal to 3 mm (preferably 2 mm), and the width W2 of the single metal sheet 40 is substantially greater than or equal to 6 mm and smaller than or equal to 25 mm (preferably 12.8 mm).

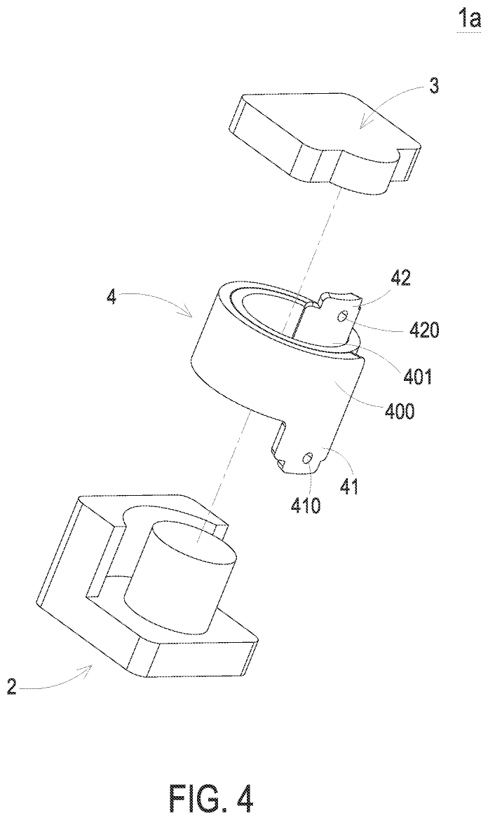

FIG. 4 is a schematic exploded view illustrating an inductor module according to a second embodiment of the present disclosure. Component parts and elements corresponding to those of the first embodiment are designated by identical numeral references, and detailed descriptions thereof are omitted. The winding assembly 4 of the inductor module la of this embodiment includes a first end part 400, a second end part 401 and a first conducting part 41. The first end part 400 and the second end part 401 are disposed at two opposed ends of the winding assembly 4. Particularly, the first end part 400 is disposed at the outer side of the winding assembly 4, and the second end part 401 is disposed at the inner side of the winding assembly 4. The first conducting part 41 is integrally formed with the first end part 400 of the winding assembly 4 and extended along a direction toward the first magnetic core 2 (i.e., extended downwardly) from the first end part 400 of the winding assembly 4. The first conducting part 41 of the winding assembly 4 can be connected with a transformer (not shown) and/or a system board (not shown) in a welding manner.

In some embodiments, the winding assembly 4 further includes a second conducting part 42. The second conducting part 42 is integrally formed with the second end part 401 of the winding assembly 4 and extended along a direction toward the second magnetic core 3 (i.e., extended upwardly) from the second end part 401 of the winding assembly 4. The second conducting part 42 of the winding assembly 4 can be connected with a transformer (not shown) and/or a system board (not shown) in a welding manner.

As mentioned above, the first conducting part 41 and the second conducting part 42 are directly extended from the first end part 400 and the second end part 401 of the winding assembly 4, respectively. Consequently, it is not necessary to additionally welding copper bars to be directly connected with the transformer and/or the system board. Since the number of welding points on the winding assembly 4 of the inductor module la is largely reduced, the current-flowing area of the winding assembly 4 is increased. In other words, the inductor module la is suitably applied to the high-power product.

The extending directions of the first conducting part 41 and the second conducting part 42 from the first end part 400 and the second end part 401 of the winding assembly 4 are not restricted as long as the first conducting part 41 and the second conducting part 42 are not contacted with the first magnetic core 2 and the second magnetic core 3. The first conducting part 41 and the second conducting part 42 are respectively extended from the first end part 400 and the second end part 401 of the winding assembly 4 along a required direction in a bending manner.

In some embodiments, the first conducting part 41 includes a first opening 410, and the second conducting part 42 includes a second opening 420. Due to the first opening 410 and the second opening 420, the winding assembly 4 can be welded on the transformer and/or the system board more securely, and the amount of the heat transferred to the winding assembly 4 during the welding process will be reduced.

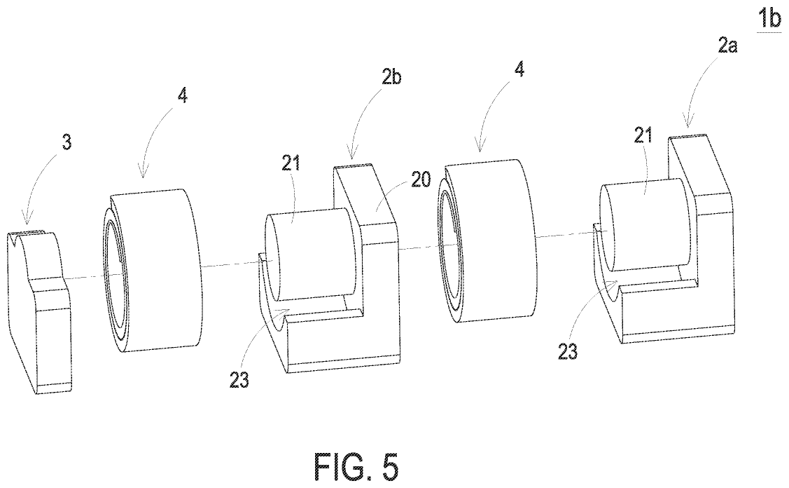

FIG. 5 is a schematic exploded view illustrating an inductor module according to a third embodiment of the present disclosure. Component parts and elements corresponding to those of the first embodiment are designated by identical numeral references, and detailed descriptions thereof are omitted. In this embodiment, the inductor module 1b includes two first magnetic cores 2a, 2b, a second magnetic core 3 and two winding assemblies 4. In other words, the inductor module 1b has a multi-inductor structure. The structures of the two first magnetic cores 2a and 2b are identical to the structure of the first magnetic core 2 as shown in FIG. 1. The structure of the second magnetic core 3 in this embodiment is identical to the structure of the second magnetic core 3 as shown in FIG. 1. The structures of the two winding assemblies 4 in this embodiment are identical to the structure of the winding assembly 4 as shown in FIG. 1.

In this embodiment, the number of the winding assemblies 4 is equal to the number of the first magnetic cores. For example, the inductor module 1b includes two first magnetic cores 2a and 2b and two winding assemblies 4. The two winding assemblies 4 are disposed around the corresponding first posts 21 of the first magnetic cores 2a and 2b, respectively. A portion of each winding assembly 4 is accommodated within the winding groove 23 of the corresponding first magnetic core. In this embodiment, the first magnetic core 2b is arranged between the first magnetic core 2a and the second magnetic core 3. The top surface of the first post 21 of the first magnetic core 2b is disposed adjacent to the second magnetic core 3. The top surface of the first post 21 of the first magnetic core 2a is disposed adjacent to the connection part 20 of the first magnetic core 2b.

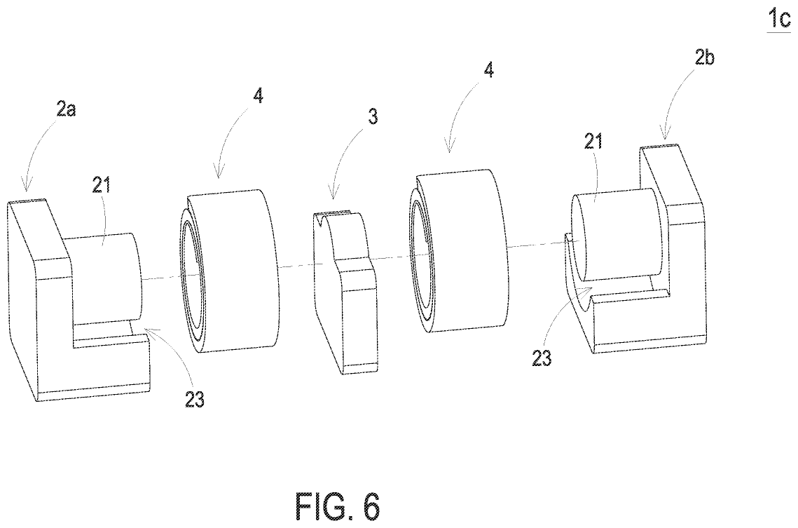

FIG. 6 is a schematic exploded view illustrating an inductor module according to a fourth embodiment of the present disclosure. Component parts and elements corresponding to those of the first embodiment are designated by identical numeral references, and detailed descriptions thereof are omitted. In this embodiment, the inductor module 1c includes two first magnetic cores 2a, 2b, a second magnetic core 3 and two winding assemblies 4. In other words, the inductor module 1c has a multi-inductor structure. The structures of the two first magnetic cores 2a and 2b are identical to the structure of the first magnetic core 2 as shown in FIG. 1. The structure of the second magnetic core 3 in this embodiment is identical to the structure of the second magnetic core 3 as shown in FIG. 1. The structures of the two winding assemblies 4 in this embodiment are identical to the structure of the winding assembly 4 as shown in FIG. 1.

In this embodiment, the number of the winding assemblies 4 is equal to the number of the first magnetic cores. For example, the inductor module 1c includes two first magnetic cores 2a and 2b and two winding assemblies 4. The two winding assemblies 4 are disposed around the corresponding first posts 21 of the first magnetic cores 2a and 2b, respectively. A portion of each winding assembly 4 is accommodated within the winding groove 23 of the corresponding first magnetic core. In this embodiment, the second magnetic core 3 is arranged between the first magnetic core 2a and the first magnetic core 2b. A first surface of the second magnetic core 3 is disposed adjacent to the first post 21 of the first magnetic core 2a. A second surface of the second magnetic core 3 is disposed adjacent to the first post 21 of the first magnetic core 2b.

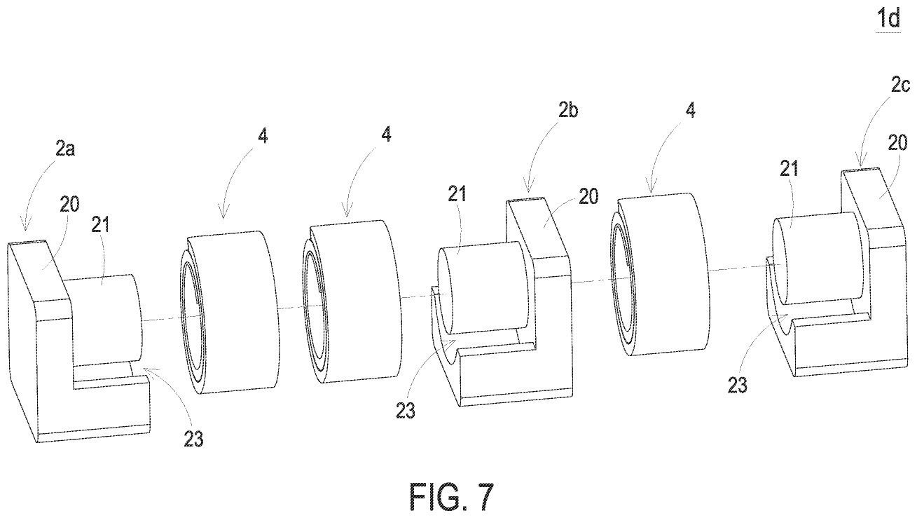

FIG. 7 is a schematic exploded view illustrating an inductor module according to a fifth embodiment of the present disclosure. Component parts and elements corresponding to those of the first embodiment are designated by identical numeral references, and detailed descriptions thereof are omitted. In this embodiment, the inductor module 1d includes three first magnetic cores 2a, 2b, 2c and three winding assemblies 4. In other words, the inductor module 1d has a multi-inductor structure. The structures of the three first magnetic cores 2a, 2b and 2c are identical to the structure of the first magnetic core 2 as shown in FIG. 1. The structures of the three winding assemblies 4 in this embodiment are identical to the structure of the winding assembly 4 as shown in FIG. 1.

In this embodiment, the number of the winding assemblies 4 is equal to the number of the first magnetic cores. For example, the inductor module 1c includes three first magnetic cores 2a, 2b, 2c and three winding assemblies 4. The three winding assemblies 4 are disposed around the corresponding first posts 21 of the first magnetic cores 2a, 2b and 2c, respectively. A portion of each winding assembly 4 is accommodated within the winding groove 23 of the corresponding first magnetic core. In this embodiment, the first magnetic core 2b is arranged between the first magnetic core 2a and the first magnetic core 2c. The top surface of the first post 21 of the first magnetic core 2a is disposed adjacent to the top surface of the first post 21 of the first magnetic core 2b. The top surface of the first post 21 of the first magnetic core 2c is disposed adjacent to the connection part 20 of the first magnetic core 2b.

Moreover, each of the inductor modules 1, 1a, 1b, 1c and 1d can be applied to a power conversion circuit of a power supply and served as the output inductor of the power conversion circuit. An example of the power conversion circuit includes but is not limited to a full bridge phase shift converter, a half bridge converter, a full bridge converter, a forward converter, a push pull converter, a buck converter, a half bridge LLC series resonant converter or a full bridge LLC series resonant converter.

From the above descriptions, the present disclosure provides an inductor module. The winding assembly of the inductor module is formed by wrapping a single metal sheet. Consequently, the volume of the winding assembly is reduced, and only a smaller winding space is required. The volume reduction is helpful for the miniaturization of the inductor module. Moreover, since the copper loss of the winding assembly is reduced, the efficiency of the inductor module is increased. Moreover, the first magnetic core of the inductor module comprises two posts (i.e., the first post and the second post). Since the heat generated by the first magnetic core can be dissipated along three lateral directions, the heat dissipating efficiency of the inductor module is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An inductor module, comprising:
at least one first magnetic core, wherein each first magnetic core comprises a connection part, a first post and a second post, wherein the first post and the second post are disposed on a top surface of the connection part, and a winding groove is formed between the first post and the second post;
a second magnetic core disposed adjacent to the first magnetic core; and
at least one winding assembly, wherein each winding assembly is formed by wrapping a single metal sheet for at least one turn, and each winding assembly is disposed around the first post of the corresponding first magnetic core, wherein a portion of each winding assembly is accommodated within the winding groove of the corresponding first magnetic core, and an overall thickness of the winding assembly within the winding groove is smaller than or equal to a width of the winding groove and greater than 0.9 times the width of the winding groove.

2. The inductor module according to claim 1, wherein the second magnetic core is an I-shaped core.

3. The inductor module according to claim 1, wherein the first post has a cylinder-shaped structure, and the second post has a structure selected from a group consisting of an arch-shaped structure, a cylinder-shaped structure, a cube structure, a cuboid structure, a trapezoid structure, an ellipsoid structure, an irregular geometry-shaped structure and the combination thereof.

4. The inductor module according to claim 1, wherein the first post has a top surface, the second post has a top surface, and an area of the top surface of the first post and an area of the top surface of the second post are equal.

5. The inductor module according to claim 1, wherein each winding assembly is formed by wrapping a single metal sheet for one turn, two turns or no more than three turns.

6. The inductor module according to claim 1, wherein a ratio of a width of the single metal sheet to a thickness of the single metal sheet is greater than or equal to 0.5 and smaller than or equal to 20.

7. The inductor module according to claim 1, wherein a thickness of the single metal sheet is in a range between 1 mm and 3 mm, and a width of the single metal sheet is in a range between 6 mm and 25 mm.

8. The inductor module according to claim 1, wherein each winding assembly comprises a first end part, a second end part and a first conducting part, wherein the first end part and the second end part are disposed at two opposed ends of the winding assembly, and the first conducting part is extended along a direction toward the first magnetic core from the first end part.

9. The inductor module according to claim 8, wherein each winding assembly further comprises a second conducting part, and the second conducting part is extended along a direction toward the second magnetic core from the second end part.

10. The inductor module according to claim 9, wherein the first conducting part comprises a first opening, and the second conducting part comprises a second opening.

11. The inductor module according to claim 1, wherein the inductor module is served as at least one output inductor of a power conversion circuit, wherein the power conversion circuit is a full bridge phase shift converter, a half bridge converter, a full bridge converter, a forward converter, a push pull converter, a buck converter, a half bridge LLC series resonant converter or a full bridge LLC series resonant converter.

12. The inductor module according to claim 1, wherein the at least one first magnetic core comprises two first magnetic cores, the at least one winding assembly comprises two winding assemblies, and the two winding assemblies are respectively disposed around the corresponding first posts of the two first magnetic cores, wherein a first one of the two first magnetic cores is arranged between a second one of the two first magnetic cores and the second magnetic core, the first post of the first one of the two first magnetic cores is disposed adjacent to the second magnetic core, and the first post of the second one of the two first magnetic cores is disposed adjacent to the connection part of the first one of the two first magnetic cores.

13. The inductor module according to claim 1, wherein the at least one first magnetic core comprises two first magnetic cores, the at least one winding assembly comprises two winding assemblies, and the two winding assemblies are respectively disposed around the corresponding first posts of the first magnetic cores, wherein the second magnetic core is arranged between the two first magnetic cores, a first surface of the second magnetic core is disposed adjacent to the first post of a first one of the two first magnetic cores, and a second surface of the second magnetic core is disposed adjacent to the first post of a second one of the two first magnetic cores.

14. An inductor module, comprising:
three first magnetic cores, wherein a first one of the three first magnetic cores is arranged between a second one of the three first magnetic cores and a third one of the three first magnetic cores, and each of the three first magnetic cores comprises a connection part, a first post and a second post, wherein the first post and the second post are disposed on a top surface of the connection part, and a winding groove is formed between the first post and the second post; and
at least one winding assembly, wherein each winding assembly is formed by wrapping a single metal sheet for at least one turn, and each winding assembly is disposed around the first post of the corresponding one of the three first magnetic cores, wherein a portion of each winding assembly is accommodated within the winding groove of the corresponding one of the three first magnetic cores, and an overall thickness of the winding assembly within the winding groove is smaller than or equal to a width of the winding groove and greater than 0.9 times the width of the winding groove,
wherein the first post of the first one of the three first magnetic cores is disposed adjacent to the first post of the second one of the three first magnetic cores, and the connection part of the first one of the three first magnetic cores is disposed adjacent to the first post of the third one of the three first magnetic cores.
